(19) United States
(12) Patent Application Publication
(10) Pub. No.: US 2008/0277084 A1
(43) Pub. Date: Nov. 13, 2008

(54) ASA Sizing Emulsions For Paper and Paperboard

(75) Inventors: Daniel H. Denowski, Millington, TN (US); Manuel Ruiz, Bartlett, TN (US); Walter B. Hill, JR., Germantown, TN (US)

Correspondence Address: KILYK & BOWERSOX, P.L.L.C., 400 HOLIDAY COURT, SUITE 102, WARRENTON, VA, 20186, US

(73) Assignee: BUCKMAN LABORATORIES INTERNATIONAL, INC., Memphis, TN (US)

(21) Appl. No.: 12/117,377

(22) Filed: May 8, 2008

Related U.S. Application Data
(60) Provisional application No. 60/928,388, filed on May 9, 2007.

(51) Int. Cl. D21H 21/16; C08L 61/32

(52) U.S. Cl. 162/164.6; 524/598

(57) ABSTRACT

ASA sizing emulsions are described, as well as emulsifying agents containing starch and a terpolymer of acrylamide/quaternary ammonium compound/glyoxal, and an ASA blend that contains ASA and a co-surfactant blend of anionic surfactant and nonionic surfactant. Processes for sizing paper products with the emulsions are also described.

This application claims the benefit under 35 U.S.C. §119(e) of prior U.S. Provisional Patent Application No. 60/928,388, filed May 9, 2007, which is incorporated in its entirety by reference herein.

### BACKGROUND OF THE INVENTION

The present invention relates to emulsions of alkenyl succinic anhydrides (ASA) and their use to size paper and paperboard. The present invention relates to an ASA emulsifying agent containing at least starch and a terpolymer of acrylamide/quaternary ammonium compound/glyoxal. Also, the present invention relates to an ASA blend formulation containing at least a co-surfactant blend of anionic surfactant and nonionic surfactant and ASA. The ASA blend can be combined with the ASA emulsifying agent to form an ASA sizing emulsion.

Certain sizing agents have been used in paper and paperboard production to obtain products having enhanced resistance against penetration of aqueous solutions. The use of certain ASA emulsions to size paper has been described, for example, in U.S. Pat. Nos. 3,102,064; 3,821,069; 3,968,005; 4,040,900, and 5,962,555. Though they have been widely used in the papermaking industry, the current ASA sizing emulsions have had some drawbacks. For instance, ASA materials are not water soluble and, therefore, must be uniformly suspended in paper pulp to permit sufficient contact with the pulp fibers to achieve the desired sizing effect on the final paper product. ASA, an oil based material, must be emulsified at some point before use as a sizing agent. Various cationic agents have been employed to address this drawback and obtain more efficient sizing. U.S. Pat. No. 4,657,946 relates to the use of cationically charged water-soluble vinyl addition and condensation polymers to provide emulsification of ASA sizing agents. U.S. Pat. No. 4,606,773 describes ASA sizing emulsions using a cationic water-soluble polymer and a cationic starch as an emulsifier. The polymer is used, in an aqueous system, to help disperse the ASA droplets (particle size) in an emulsion, and keep them from coagulating together, and forming much larger droplets. With increasing use of ASA sizing emulsions, there remains a need for further improvements in their performance capabilities. Ideally, new emulsions could be prepared on standard shear equipment to help control production costs.

Also, attractive alternatives are desired relative to other paper sizing agents currently in use, such as alkylketene dimer (AKD) and rosin sizing products. For instance, AKD has drawbacks, such as its need to be cured in storage to develop its complete size. Previously, starch also has been used to emulsify ASA, then cationic starch for providing a charge helping to retain the ASA on the fiber. However, both had to be prepared on-site in a paper mill with specialized heating equipment, which is inconvenient and increases production costs. Sizing emulsifiers that are easier to prepare, handle, store, and use are needed.

### SUMMARY OF THE INVENTION

A feature of the present invention is to provide high performance ASA sizing emulsions. Another feature is to provide ASA emulsions with a small ASA particle size (or droplet size) that can provide high sizing and/or high water resistances.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to an ASA emulsifying agent containing at least starch and acrylamide/quaternary ammonium compound/glyoxal terpolymer. This emulsifying agent can be added or combined with an ASA and water to form an ASA emulsion. The emulsion can optionally contain at least one surfactant, such as an anionic surfactant and/or a nonionic surfactant. The present invention further relates to a blend containing at least ASA and anionic surfactant and nonionic surfactant.

In various embodiments, the ASA sizing emulsion can comprise from about 0.5 to about 3.0 weight % ASA (or ASA blend), from about 0.1 to about 1.5 weight % starch, from about 0.1 to about 1.5 weight % terpolymer, and from about 94 to about 99.3 weight % water based on the weight of the emulsion. The terpolymer can comprise from 1 to 99 weight % acrylamide, from 1 to 99 weight % quaternary diallyamine, and from 0.01 to 50 weight % glyoxal, based on the weight of the terpolymer. Unless stated otherwise, all weight percents provided herein are based on the total weight of the emulsion or formulation. The quaternary ammonium compound may be, for example, a quaternary ammonium salt monomer, such as dimethyldiallyl ammonium chloride. The starch may be, for example, cationic starch, such as ethoxylated starch. The ASA blend can contain from about 90 to about 99 weight % ASA, from about 0.1 to about 10 weight % anionic surfactant, and from about 0.1 to about 10 weight % nonionic surfactant based on the total weight of the ASA blend. The anionic surfactant may be, for example, dioctyl sulfosuccinate and salts thereof. The nonionic surfactant may be, for example, polyoxyalkylene alkyl ethers. When the ASA blend is part of the ASA sizing emulsion containing the terpolymer and starch, the overall ASA sizing emulsion can contain from about 0.5 to about 3 weight % ASA blend, which can amount to from about 0.6 to about 2.4 weight % ASA, and from about 0.1 to about 0.3 weight % anionic surfactant, and from about 0.1 to about 0.3 weight % nonionic surfactant present in the overall ASA sizing emulsion. In one or more embodiments, the ASA sizing emulsion of the present invention can have an HST value of at least 1000 seconds, particularly at least 1500 seconds, when dosed at 4 lb./ton in sizing 100% OCC. In one or more embodiments, the ASA sizing emulsion can have a HST value of at least 10 seconds when dosed at 4 lb./ton in sizing #30 sulfite pulp. In addition or alternatively, the ASA sizing emulsion can have a Cobb sizing value, based on one minute, ranging from about 20 to about 100 grams per square meter for paperboard (or from 50 to about 200 gsm for paper).

In one or more embodiments, a process for sizing paper is provided that comprises using at least one of the ASA emulsions of the present invention for surface or stock sizing. In various embodiments, the process comprises dispersing within wet paper pulp, or, after conversion of such pulp into paper treating it with a sizing emulsion in an aqueous medium, using one of the ASA sizing emulsions of the present invention. The ASA emulsions of the present invention can be used for sizing in the production of paper and paperboard products such as office papers, gypsum-board liner, corrugated paper, envelope paper, and other paper products.

Amongst additional advantages and benefits, the ASA emulsions of the present invention made with the starch and terpolymer emulsifier can be prepared on standard high shear make-down equipment. The ASA emulsions that contain the anionic/nonionic co-surfactant blend can obtain a small ASA particle size (or droplet size) on less costly, low shear make-down equipment. These ASA sizing emulsions are also easy to handle, need not be prepared in the paper mill, and do not require special storage measures. For instance, the ASA emulsions of the present invention do not require specialized heating equipment in the paper mill, unlike previous uses of cationic starch in ASA emulsions. As shown, for example, in the examples provided herein, the sizing performance enhancements obtained with ASA emulsions of the present invention significantly surpass results achieved with comparative ASA products using grafted starch emulsifier or only individual ones or lesser included combinations of the emulsifier agent components. As also shown in the examples provided herein, the ASA emulsions of the present invention also provide paper products having enhanced properties such as in terms of water resistance, MD tensile strength, and CD tensile strength in comparison to similar paper products sized with prior ASA emulsions formulated with conventional polyacrylamide copolymers. The sizing improvements obtained with the ASA emulsions of the present invention are also considered to exceed mere additive effects of the individual emulsifier agent components.

It is to be understood that both the foregoing general description and the following detailed description are exemplary and explanatory only and are only intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF THE DRAWINGS

FIG. 1 is a graph showing Cobb values over time for gypsum-board liner sized with an ASA emulsion in accordance with an embodiment of the present invention and a comparative ASA emulsion formulated with polyacrylamide copolymer instead of the terpolymer used in ASA emulsions in accordance with the present teachings.

FIG. 2 is a graph showing MD Tensile values over time for gypsum-board liner sized with an ASA emulsion in accordance with an embodiment of the present invention and a comparative ASA emulsion formulated with polyacrylamide copolymer instead of the terpolymer used in ASA emulsions in accordance with the present teachings.

FIG. 3 is a graph showing CD Tensile values over time for gypsum-board liner sized with an ASA emulsion in accordance with an embodiment of the present invention and a comparative ASA emulsion formulated with polyacrylamide copolymer instead of the terpolymer used in ASA emulsions in accordance with the present teachings.

### DETAILED DESCRIPTION OF THE PRESENT INVENTION

The present invention relates to compositions for sizing paper and paperboard. As used herein, the term “paper” includes all grades of paper and paperboard. The terms “emulsifying agent” and “emulsifier” are used interchangeably, and may refer to physical and/or chemical combinations of different components or individual components, depending on context. For purposes of the present invention, an emulsifying agent assists the suspension of ASA particles in an aqueous medium. In part, the present invention relates to an emulsifying agent comprising at least one starch and at least one terpolymer of acrylamide/quaternary ammonium compound/glyoxal. The emulsifying agent can be used to emulsify ASA or a formulation containing ASA, such as an ASA blend. An ASA blend can be a co-surfactant blend of at least one anionic surfactant and at least one nonionic surfactant that is blended with ASA, which has been found to preferably provide ASA emulsions with small ASA particle sizes (ASA droplet sizes) that can provide significantly improved sizing performance on paper and paperboard. Thus, the present invention also relates to an ASA emulsion that contains the emulsifying agent of the present invention, ASA (or an ASA blend) and water, wherein the ASA blend can be the co-surfactant blend with ASA of the present invention.

With respect to the ASA that is present in the emulsion, the ASA, as is known in the art, represent a class of alkenyl succinic anhydride compounds (ASA) having the following general formula: R¹-R—C(O)—O—C(O). In the general formula, R is a dimethylenyl or trimethylenyl group and R¹ is a hydrophobic group having five or more carbon atoms. R¹ may be, for example, an alkyl, alkenyl, aralkyl, or arakenyl group. In one embodiment, for purposes of papermaking, the components of this monomer can include a five-membered anhydride ring and a linear chain having between 14 and 20 —CH₂— groups, and the reactive ring can be located at various positions relative to the chain. Commercial ASA can comprise a mixture of these isomers. ASA typically is obtained in the form of an oily monomer. The product can be supplied and handled, for example, as a light amber oil. However, any ASA material may be used in an ASA sizing emulsion according to the present invention. Sources of ASA include, for example, Albermarle Corporation, Baton Rouge, La. and Dixie Chemical Company, Houston, Tex. Other examples of the ASA are provided in the literature, for example, in U.S. Pat. Nos. 4,545,856, 4,606,773, 4,849,131, and 4,695,401, which are incorporated herein by reference. Before the ASA size can be distributed onto fiber surfaces in the slurry of pulp, for example, it first has to be emulsified. The emulsion can comprise small droplets of ASA oil, with starch and an acrylamide terpolymer in accordance with embodiments of the invention, in a continuous phase of aqueous solution. With the present invention, the ASA (in the emulsion and/or in the processing stream containing the pulp or paper) can have an average particle (droplet) size ranging from about 0.5 to 1.5 microns. Preferably, the average particle size ranges from 0.5 to 1 micron, or 0.2 to 0.5 micron, or 0.3 to 0.85 micron, or 0.4 to 0.7 micron, and can be less than 1 micron. Other particle sizes are possible. The particle size is a number-average particle size as determined by a Horiba LA-300 particle size analyzer.

In various embodiments, an emulsifying agent for ASA is provided comprising at least starch and a terpolymer of acrylamide/quaternary ammonium compound/glyoxal. In one embodiment, only starch and the terpolymer are used to emulsify ASA or an ASA blend.

This emulsifying agent may be used to prepare an ASA sizing emulsion by emulsifying ASA or an ASA blend. For instance, the emulsion can contain from about 0.5 to about 3 weight % ASA (or ASA blend), from about 0.1 to about 1.5 weight % starch, from about 0.1 to about 1.5 weight % terpolymer, and from about 94 to about 99.3 weight % water based on the total weight of the ASA emulsion. The ASA emulsion can contain at least: from about 1 to about 2 weight % ASA (or ASA blend), from about 0.5 to about 1 weight % starch, from about 0.5 to about 1 weight % terpolymer, and from about 95 to about 99 weight % water. The reference to “blended ASA” or “ASA blend” is a reference to an ASA blended with at least one surfactant, such as two different types of surfactants. The surfactant can be at least one anionic surfactant, at least one nonionic surfactant, a combination thereof, and/or one or more other surfactants, and other optional ingredients/components can be present, such as one or more of the ingredients described in the patents identified above or below.

In one or more embodiments, the emulsifying agent of the present invention combines at least one dry strength terpolymer and at least one starch. The polymer-starch blend of this emulsifying agent performs substantially better at emulsifying ASA and sizing paper than the current known products. These emulsifying agents can make ASA emulsions with a small average ASA particle size, higher sizing such as measured by HST (Hercules Size Testing) and/or higher water resistances, such as measured by the standard COBB method using standard high shear make-down equipment. This emulsifying agent can also provide an easy to handle ASA sizing emulsion competitive with AKD and rosin sizing products, and other current methods for emulsifying ASA, such as starch, DMDDAAC-acrylamide copolymers, and combinations with AKD and grafted starch. Another advantage is that it does not need to be made in the mill with specialized heating equipment as starch does. Another advantage is that it can replace alkylketene dimer (AKD) sizing which needs to cure in storage to develop its complete size while ASA does not. The emulsifying agent can have other uses, such as in pitch control, fines and anionic trash retention, retention of other papermaking additives, and so forth. In addition, the emulsifying agent is FDA and TSCA allowed and both individually, are common paper additives, which should facilitate introduction into commercial production.

With respect to the components of the terpolymer, as used herein, the term “acrylamide” refers to acrylamide monomers and/or small molecular weight oligomers. Acrylamide monomers may include primary vinylamides, including not only acrylamide itself, but also substituted acrylamides such as methacrylamide, ethylacrylamide, crotonamide, N-methyl acrylamide, N-butyl acrylamide, N-ethyl methacrylamide and the like. Polyacrylamides, which are polymers made from acrylamide monomers, may include repeating units from at least some of these various compounds. The acrylamide oligomers may have a weight average molecular weight up to about 500 Daltons (e.g., 10 to 500 Daltons). While acrylamide is a preferred nonionic monomer for use in preparing polymers useful in emulsifying agents of this invention, other nonionic monomers, such as methacrylamide, or other monomers exemplified above, or even certain anionically charged monomers, such as acrylic acid, methacrylic acid, various sulfonated water soluble vinyl addition monomers, and the like, can be used. The acrylamide monomers and/or oligomers may be utilized from commercial materials, such as Acrylamide 50 manufactured by American Cyanamid.

The quaternary ammonium compound that in part forms the terpolymer, may be, for example, a quaternary ammonium salt monomer. The quaternary ammonium compound may be, for example, dimethyldiallylammonium chloride (DMDAAC), dimethylaminoethylacrylate methyl chloride quaternary salt, dimethylaminoethylmethacrylate methyl chloride quaternary salt, dimethylaminoethylacrylate benzyl chloride quaternary salt, or dimethylaminoethylmethacrylate benzyl chloride quaternary salt, and the like, singly or in any combinations thereof. The quaternary ammonium compound particularly may be a diallyl ammonium monomer, such as dimethyldiallylammonium chloride (DMDAAC). In addition to chloride, the counterion for these monomers also can be fluoride, bromide, iodide, sulfate, methylsulfate, phosphate, and the like.

The glyoxal that is part of the terpolymer is a known aldehyde having the general structure CHOCHO.

The starch may be any type of starch, for example, a cationic starch. Cationic starches useful in this invention are disclosed in U.S. Pat. Nos. 4,606,773, 4,029,885, 4,146,515, 3,102,064, and 3,821,069, all of which are hereinafter incorporated by reference. Particular starches useful in this invention are ethoxylated starch, cationic potato starch, cationic corn starch, cationic tapioca starch, and so forth. Starch materials of these types are available commercially.

The emulsifying agent can be prepared as follows, and then used in the emulsification of ASA. The acrylamide and quaternary ammonium compound components of the terpolymer may be individually reacted together with the glyoxal as a single pot operation, or, alternatively, the acrylaride and quaternary ammonium compound components may be co-polymerized prior to being further reacted with the glyoxal to form the terpolymer. The polymerization reactions of the acrylamide, quaternary ammonium compound and glyoxal can be initiated, such as with ammonium persulfate (e.g., dilute ammonium persulfate) or other suitable initiator. The copolymerization reactions are generally initiated using free radical polymerization initiators that are generally known to those skilled in the art. Compounds which form mainly water soluble radicals are suitable as polymerization initiators, such as persulfate salts, peroxide polymerization initiators, azostarters, redox catalysts, and so forth. These types of initiators can be used either alone or in combination with one another. For example, ammonium persulfate may be used. The rate of polymerization can be affected by various variables including the concentration of initiator and reaction temperature. The rate of polymerization generally has a positive relationship with each of these variables, for example, higher initiator concentration or higher temperature generally results in increases in rate of polymerization, but not necessarily always. A temperature generally of from about 50 to about 100° C., particularly from about 65 to about 85° C., is preferably provided and maintained for the polymerization reactions. Ammonium persulfate is generally unstable in water and preferably is added incrementally over a period of time. It is preferable to keep the reaction mixture well mixed throughout the reaction in order to obtain a good distribution of the various monomers throughout the resulting copolymer. However, care should be taken to avoid mixing that is too intense such that degradation of the polymeric product occurs. Water is preferably used as the reaction solvent for the polymerization reaction, although it not limited thereto. Where water is used as the reaction solvent, the reaction may be conducted under reduced pressure, although not limited thereto. In preparing the terpolymer, the mole ratio of the finished terpolymer of acrylamide, quaternary ammonium compound, and glyoxal components may be 0.1-99:0.1-99:0.01-50, respectively. Specific examples include 1-90:1-90:1-45, or 5-80:5-80:5-40, or 10-75:10-70:15-30, or 20-50:20-50:20-25, or 30-40:30-40:20-25, all respectively.

The starch generally is heated (or converted) in aqueous solution, such as from about 40° C. to about 10° C. depending on the starch, prior to combination with the other components of the emulsion. The starch may be combined in aqueous solution with the acrylamide/quaternary ammonium compound co-polymer before, during, and/or after addition of the glyoxal.

In one aspect of the present invention, an ASA blend can be prepared and used, wherein the blend contains a co-surfactant blend of anionic surfactant and nonionic surfactant, with an ASA.

The ASA blend can contain from about 90 to about 99 weight % ASA, from about 0.1 to about 10 weight % anionic surfactant, and from about 0.1 to about 10 weight % nonionic surfactant, based on the weight of the ASA blend. For instance, the ASA blend can contain from about 95 to about 99 weight % ASA, from about 1 to about 5 weight % anionic surfactant, and from about 1 to about 5 weight % nonionic surfactant, each based on the total weight percent of the ASA blend. The anionic surfactant and nonionic surfactant can be present in equal weight ratios or in a weight ratio of from 0.75:1.25 to 1.25:0.75.

The anionic surfactant can be a sulfosuccinate ester, e.g., esters of sulfosuccinic acid with alcohols usually alcohols comprising from 6 to 20 carbon atoms, exemplified by dialkyl sulfosuccinates, such as dioctyl sulfosuccinate (DOSS), di-2-ethylhexylsulphonsuccinate, and dicycloalkyl sulfosuccinates such as dicyclohexyl sulphosuccinate, or salts thereof. In a particular embodiment, the anionic surfactant may be dioctyl sulfosuccinate or salts thereof, such as a sodium salt of DOSS in water and/or ethanol. Commercial sources of DOSS include, for example, ASCOT DOSS, and so forth. Other anionic surfactants may be used, and include, for example, those described in U.S. Pat. No. 5,962,555, which are incorporated herein by reference.

The nonionic surfactant can be a polyoxyalkylene compound, such as a polyoxyalkylene alkyl ether, which may comprise a hydrophobic moiety having at least 8 carbons, notably from 8 carbon atoms and up to 36 carbon atoms. The hydrophobic moiety can contain other atoms than carbon and hydrogen as long as the moiety has an overall hydrophobic character. The hydrophobic moiety can be a linear, branched, non-branched, saturated or unsaturated hydrocarbon (or combinations thereof) suitably containing aromatic functionalities such as aromatic ring systems or fused aromatic ring systems, wherein the aromatic systems can be a part of the main hydrocarbon structure or being pendent groups linked to the branched or non-branched main hydrocarbon structure. Preferably, the hydrophobic moiety is a non-branched saturated hydrocarbon chain which may contain from 8 up to 36 carbon atoms, suitably from 10 up to 20 carbon atoms, and most preferably from 10 up to 15 carbon atoms. The polyoxyalkylene compound may have from 2 up to 30 alkylene oxide units of the same type or different types, commonly from 5 up to 10 alkylene oxide units, and preferably from 5 up to 8 alkylene oxide units. Most particularly, the polyoxyalkylene compound may contain ethylene oxide and/or propylene oxide units, such as ethylene oxide units in an amount of from 5 up to 10 ethylene oxide units, preferably from 5 up to 7 ethylene oxide units. The weight average molecular weight of the polyoxyalkylene compound can be up to 4000, suitably from 200 up to 2300. Suitably, the polyoxyalkylene compound can be polyethylene glycol monooleyl ether, tetra(ethylene glycol) undecyl ether, penta(ethylene glycol) undecyl ether, hexa(ethylene glycol) undecyl ether, hepta(ethylene glycol) undecyl ether, and/or deca(ethylene glycol) undecyl ether. A non-limiting example of a polyoxyalkylene alkyl ether that may be used, is polyethylene glycol monooleyl ether, also referred to as polyoxyethylene (20) oleyl ether, which commercially available as BRIJ 98.

The ASA blend of the present invention can provide an ASA product which is easy to emulsify without the need for the conventionally used extensive high-shear equipment that have been used in preparing conventional ASA emulsions. The ASA with the co-surfactant blend of anionic/nonionic surfactants can be emulsified or homogenized with less costly, low-shear equipment. The emulsifying agents and/or ASA blend or their combination preferably make ASA emulsions with small ASA particle (droplet) size, higher sizing such as measured by HST (Hercules Size Testing) and/or higher water resistances such as measured by the standard COBB method using standard high shear make-down equipment. The emulsifying agent and/or ASA blend of the present invention also permits the forming of an easy to handle ASA sizing emulsion competitive with AKD and rosin sizing products, and other current methods for emulsifying ASA such as starch, DMDDAAC-acrylamide copolymers, and combinations with AKD and grafted starch. Another advantage is that it does not need to be made in the mill with specialized heating equipment as starch does. Another advantage is that it can replace alkylketene dimer (AKD) sizing which needs to cure in storage to develop its complete size while ASA does not. The co-surfactant blend (without the ASA) has other uses, such as in defoamer emulsification, pitch control, fines and anionic trash retention, retention of other papermaking additives such as AKD and rosin size, and so forth. In addition, this blend is FDA and TSCA allowed and both individually, are common paper additives, which should facilitate introduction into commercial production.

ASA sizing emulsions of the present invention may be prepared using techniques known in the art. The emulsions may be made by mixing the various components described to emulsify or homogenize the mixture.

The emulsifying agent made with the starch and the terpolymer can be prepared on standard high shear make-down equipment, and the ASA blend with the anionic/nonionic co-surfactant blend and the emulsifying agent can be made on less costly, low shear make-down equipment. Examples of the low shear equipment for homogenization of the ASA emulsion at low shear conditions include, for example, a BTA-05-AP unit manufactured by Norchem. The resulting emulsions do not require special heating or storage measures. For purposes of the present invention, low shear refers to the ability to pump a liquid, such as an ASA emulsion (or the combination of ingredients that will form the emulsion), through a pump with a back pressure of 50 psi or less and, more preferably, 35 psi or less and, even more preferably, 10 psi or less, such as from 1 psi to 10 psi. High shear generally requires a back pressure of 150 to 300 psi to pump a liquid, such as a standard ASA emulsion. The present invention, using the emulsifying agent of the present invention in combination with the ASA blend and water, permits one to create an ASA emulsion that is easily pumped to the location in the paper mill where sizing is occurring. Furthermore, with the present invention, the pump, by itself, is sufficient to mix together the various components to form the ASA emulsion and, thus, low shear conditions are used. In at least one embodiment of the present invention, the various components that form the ASA emulsion, such as the components of the emulsifying agent of the present invention, and the components of the ASA blend can simply be added together in a container and then pumped to the desired location in the paper mill where sizing is occurring, and the pump (e.g., with a back pressure of 50 psi or less) alone can sufficiently mix the ingredients together to form an ASA emulsion useful for the present invention. Thus, the present invention permits one to easily formulate an ASA emulsion with simple equipment, such as a pump, and yet achieve desirable ASA emulsions with desirable properties, including a small average particle size of the ASA in the emulsion.

The ASA sizing emulsions of the present invention may be used as an internal and/or surface sizing composition for paper and paperboard. The emulsions may be added at the wet end and/or used to treat a surface of fibrous sheet. Also, the type of sizing agent that may be used at the wet end may be different from the ASA emulsion used as a surface sizing composition, or vice versa. When used as an internal size, the ASA emulsion may be added before the paper sheet forming step in a papermaking process. The sizing emulsions may be added, for example, to the pulp while the latter is in the headbox, beater, hydropulper or stock chest, and so forth. The sizing emulsion may be added as far back in a papermaking process as the thick stock but is most often added just before the head box of a paper machine. As is known in the art, a sizing emulsion should be added in such a way to insure proper distribution on the fibers. To insure proper distribution, a sizing emulsion can be commonly diluted to about 0.1-2% solids, then added before the screens or fan pump just prior to the pulp slurry entering the head box. This dilution, followed by dispersion by the screens and/or fan pump aids in distributing the sizing emulsion to achieve uniform distribution on the paper fibers. The emulsion may be used for internal sizing applications at a dosage (pounds ASA per ton of dry paper) that is at least about 0.1, particularly from about 1 to about 15, and more particularly from about 2 to about 8 or from 2 to 4 or from 6 to 8. The ASA emulsion disperses well and is retained on the treated pulp fibers.

In another embodiment, the ASA sizing emulsion can be applied onto the surface of a formed web. The ASA emulsion may be used for surface sizing applications at a dosage (pounds ASA per ton of dry paper) that is at least about 0.1, particularly from about 1 to about 10, and more particularly from about 2 to about 8 or from 2 to 4 or from 6 to 8.

In various embodiments, the ASA emulsion of the present invention provides an HST value of at least 100 seconds, such as at least 500 seconds, or at least 1000 seconds, or at least 1500 seconds (e.g., from 500 to 4500 seconds), when dosed at 4 lb./ton in sizing 100% OCC. In various embodiments, sizing emulsion (a) gives an HST value of at least 10 seconds when dosed at 4 lb./ton in sizing #30 sulfite pulp. It also can give a Cobb sizing value, based on one minute, ranging from about 20 to about 100 grams per square meter for paperboard (or 50 to about 200 gsm for paper).

As described above, the present invention at least relates to various embodiments using the ASA blend described above, or the emulsifying agent described above, or an emulsion that contains one or more of the above. As stated, the ASA emulsion can contain the ASA blend of the present invention. The ASA emulsion can contain the ASA blend of the present invention along with the emulsifying agent of the present invention. The ASA emulsion of the present invention can contain the emulsifying agent of the present invention with any ASA or conventional blend of ASA that is conventional in the art. The ASA blend, the emulsifying agent, or any of the above-described emulsions can be introduced into the paper mill to achieve (or contribute to) sizing of the pulp and/or paper. The ASA blend, the emulsifying agent, and/or the emulsion can be formed prior to introducing to the paper stream, to the surface of the formed web or to the pulp prior to web formation. Also, as an option, the ASA blend, the emulsifying agent, and/or the emulsion can be formed in situ in one or more feed streams, or in the pulp stream, or on the surface of the formed web. The ASA blend, the emulsifying agent, and/or the emulsion of the present invention can be formed prior to introducing, during introduction, and/or after introduction into the paper-forming process. As an option, one or more ingredients that form the ASA blend, that form the emulsifying agent, and/or that form the emulsion can be introduced sequentially, collectively, or in various combinations so as to ultimately form the ASA blend, the emulsifying agent, and/or the emulsion of the present invention, wherein this sequential introduction, or other types of introduction/feeding, can be done prior to, during, and/or after introduction to the paper-forming process stream in the appropriate location depending upon the type of ASA sizing—internal and/or surface sizing. The formation of the ASA blend, the emulsifying agent, and/or the emulsion can be by batch, continuous, or semi-continuous.

The present invention will be further clarified by the following examples, which are intended to be purely exemplary of the present invention, in which parts are proportions by weight unless otherwise specified.

### EXAMPLES

### Example 1

### Preparation of Emulsifier

The terpolymer was prepared first and then blended with converted (i.e., dispersed-heated) starch. A 40% solution of an acrylamide-DMDAAC polymer was prepared at a weight ratio of 90% acrylamide and 10% DMDAAC. Both monomers were added to water at a 40% solids concentration, heated to 80° C., and a dilute ammonium persulfate solution was added over the course of 2 hours. After cooling, the solution was diluted to 7% solids, and 0.1% glyoxal was added after pH adjustment to 8-8.5 and allowed to react at room temperature for 2 hours, providing a terpolymer. Penford® Gum 280, an ethoxylated starch, was converted at 15% in water and heated to 80° C. for 30 minutes, then mixed with the terpolymer above to give a 15% solids solution. The mixture was emulsified by low shearing for 30 seconds using a kitchen blender.

### Example 2

### Preparation of Emulsifier

The terpolymer-starch blend was prepared in a different sequence than Example 1 by dissolving the ethoxylated starch in the hot water, then adding the similarly prepared acrylamide-DMDAAC copolymer, heating to 50° C., and then adding the 0.1 weight % glyoxal, by weight of the composition/formulation.

### Example 3

### Preparation of Emulsifier

The terpolymer-starch blend was prepared in another sequence by dissolving the 7.5 weight % starch in water at 85° C., next adding acrylamide monomer (6.8 weight %) and then adding DMDAAC monomer (0.8 weight %), heating to 70° C., adding 0.1 weight % ammonium persulfate over 2 hours, and then adding 0.1 weight % glyoxal (by weight of the composition/formulation).

### Example 4

### Sizing Performance with OCC

This example demonstrates the preparation and use of an ASA sizing emulsion according to the invention. For comparison purposes, an ASA sizing emulsion as currently made in the papermaking art was used as a control. In particular, 100% recycled OCC (ol corrugated containers) from a papermill was treated with different dosages of ASA emulsified with parts amount of either a commercially available grafted starch emulsifier or the present invention's terpolymer-starch blend emulsifier of Example 1. To measure sizing efficiency, the Hercules Size Test Ink #2 was employed. For these tests, a papermill's furnish of 100% OCC, diluted to 0.5% consistency, was used along with the mill's process water. A retention aid, BUFLOC®590 product was also used in this handsheet study. BUFLOC®590 product is an emulsion polymer having a cationic acrylamide copolymer with cationized acrylate groups having a molecular weight greater than 10 million and is available from Buckman Laboratories, Inc., Memphis, Tenn. For this handsheet study, the oil-based BUFLOC®590 product was let down in water with mixing and diluted to 0.1% solids before use. The dosage of ASA sizing emulsion used in several different tests is indicated in Table 1 below, and the retention aid was included at 2 lb/ton on 1.5 g hand sheets. Hand sheets were pressed once at 50 psi and dried at 250° F. for 8 minutes.

As shown by the results in Table 1, the terpolymer-starch emulsifier resulted in a substantial increase in sizing relative to the grafted starch emulsifier at three different ASA dosage levels, as measured by Hercules Size Testing (HST) and with results reported in seconds (sec.). HST values are averaged results.

TABLE 1

| | HST Sizing Performance on 100% OCC | | |
|---|---|---|---|
| ASA Dosage | 3 lb./ton | 4 lb./ton | 5 lb./ton |
| Grafted Starch Emulsifier | 3 sec. | 92 sec. | >1500 sec. |
| Terpolymer-Starch Emulsifier | 100 sec. | >1500 sec. | >1500 sec. |

### Example 5

### Sizing Performance on Sulfite Pulp

100% sulfite pulp from a papermill was treated with different dosages of ASA emulsified with equal parts of either the grafted starch emulsifier or the terpolymer-starch blend emulsifier, which respective emulsions were similar to those tested in preceding Example 4. The sizing emulsions were introduced using emulsion dosage levels as indicated in Table 2. This was an internal application of the sizing emulsion. As shown by the results in Table 2, the terpolymer-starch emulsifier resulted in a substantial increase in sizing as measured by HST.

TABLE 2

HST Sizing
Performance on
100% sulfite pulp

| | | |
|---|---|---|
| ASA Dosage | 6 lb./ton | 8 lb./ton |
| Grafted Starch Emulsifier | 18 sec | 278 sec |
| Terpolymer-Starch | 135 sec | 869 sec |
| Emulsifier | | |

### Example 6

### Sizing Performance on 100% OCC

100% OCC obtained from a papermill that was different than the tests of Example 4 was treated with different dosages of ASA emulsified with parts amount of either the grafted starch emulsifier or the terpolymer-starch blend emulsifier having emulsified compositions similar to the Example 5. The terpolymer-starch emulsifier resulted in a substantial increase in sizing as measured by HST. Emulsion particle size was also determined on a Horiba LA-300. As shown by the results in Table 3, the particle sizes of the two tested emulsions were similar, as shown below.

TABLE 3

| | ASA/grafted | ASA/terpolymer- |
|---|---|---|
| | starch emulsifier | starch emulsifier |
| Polymer:Size Ratio | 1:1 | 1:1 |
| Median Particle Size | 0.72 μm | 0.68 μm |
| Std. Dev. | 0.32 μm | 0.27 μm |
| % Diameter<1.5 μm | 96.3 | 98.5 |
| Emulsion Time | 180 sec. | 180 sec. |

### Example 7

### Sizing Performance on Sulfite Pulp Compared with AKD

The test procedures of Example 5 were repeated except using AKD as the comparison emulsion. As shown by the results in Table 4, emulsions of ASA with the terpolymer-starch blend resulted in improved sizing on sulfite pulp compared with AKD.

TABLE 4

| | |
|---|---|
| sulfite 30# | sulfite 26# |

| | Dosage | HST | Dosage | HST |
|---|---|---|---|---|
| Sizing Additive | (lb./ton) | (sec) | (lb./ton) | (sec) |
| AKD | 4 | 2 | 6 | 106 |
| ASA/terpolymer- | 4 | 14 | 6 | 138 |
| starch emulsifier | | | | |

### Example 8

### ASA/Anionic/Nonionic Surfactant Blend

Two surfactant blends containing mixtures of ASA, an anionic surfactant, and a nonionic surfactant, were prepared. For ASA Blend A, the surfactant blend was 97% ASA, 1.5% dioctylsulfosuccinate or DOSS (Chemax commercial source) as an anionic surfactant, and 1.5% polyoxyethylene (20) oleyl ether (BRIJ 98) as a nonionic surfactant. ASA Blend B proportioned these same components differently, as shown in Table 5. The blends were homogenized using shear equipment of Norchem operated at low shear operational conditions of less than 50 psi back pressure, and then particle size was determined on a Horiba LA-300. Comparison surfactant blends were also made containing ASA and either 1% DOSS or 1% BRIJ 98, but not both, and were tested, but gave a poorer emulsion as indicated by a larger particle size. As shown by the results in Table 5, a reduction of particle size with the inventive ASA blends was observed. Table 6 shows the improvement in UST using the present invention.

TABLE 5

| | ASA:DOSS:BRIJ 98 | ASA avg. |
|---|---|---|
| | Ratio | particle size |
| ASA Blend A | 97:1.5:1.5 | 0.86-1.38 μm |
| ASA Blend B | 98:1.0:1.0 | 1.24-1.78 μm |
| ASA Comp. | 97:0:3 | 2.33 |
| Blend A | | |
| ASA Comp. | 97:3:0 | 2.05 |
| Blend B | | |

TABLE 6
HST Results (Seconds)

| | |
|---|---|
| ASA/grafted | ASA/terpolymer- |
| starch emulsifier | starch emulsifier |

| 3#/ton | 6#/ton | 3#/ton | 6#/ton |
|---|---|---|---|
| 20 | 1223 | 42 | >4100 |

### Example 9

### Sizing Performance on Gypsum-Board Liner

Gypsum-board liner made with OCC obtained from a papermill was treated at the wet end during continuous production with an ASA emulsion in accordance with an embodiment of the present invention, designated ASA Emulsion 1, and separately with a conventional ASA emulsion, designated Comparative ASA Emulsion A, at different time periods of a monitored period of continuous production. A conventional layout of equipment and liner composition for gypsum-board liner production was used for this experimental trial.

The ASA Emulsion 1 representative of the present invention was formulated with an emulsifier similar to that described in Example 1. The emulsifier and ASA oil (≈C₁₋₈ alkyl chain) were blended on a conventional low shear mechanical mixer to form an emulsion. The comparative ASA emulsion A was prepared in a similar manner as ASA Emulsion 1 except that the emulsifier was formed with a conventional polyacrylamide copolymer instead of the terpolymer. The emulsions were prepared at 0.5:1 polymer to size ratio. Emulsion samples were analyzed for particle size with a Horiba LS 300 Particle Size Analyzer. Based on particle size analysis, the inventive ASA Emulsion 1 (“1”) produced similar particle size than the Comparative ASA Emulsion A (“CA”) under similar conditions, such as shown in Table 7.

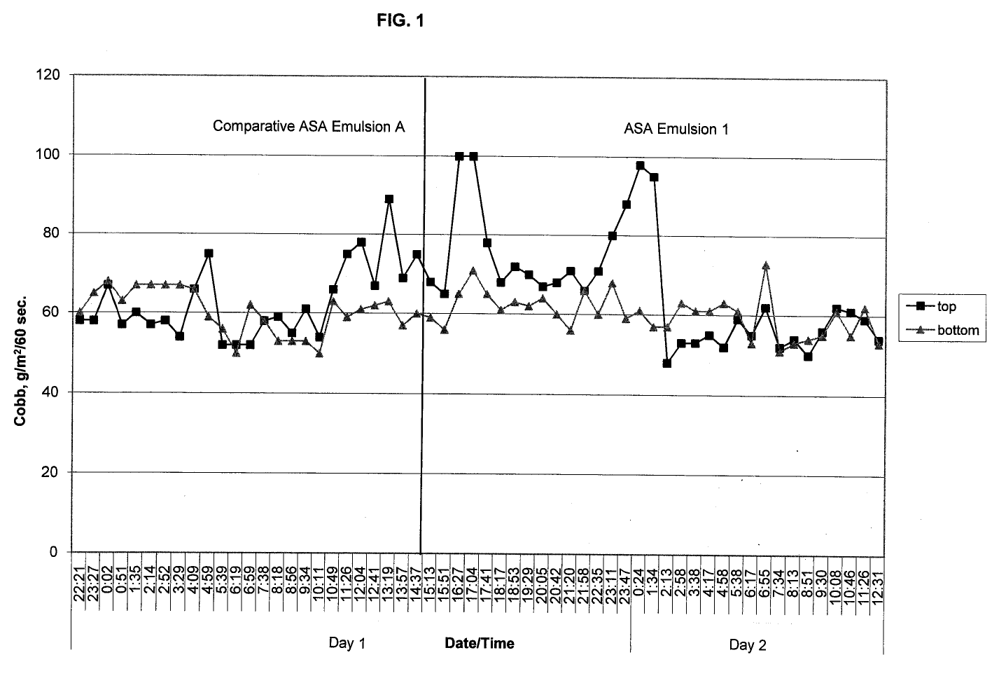

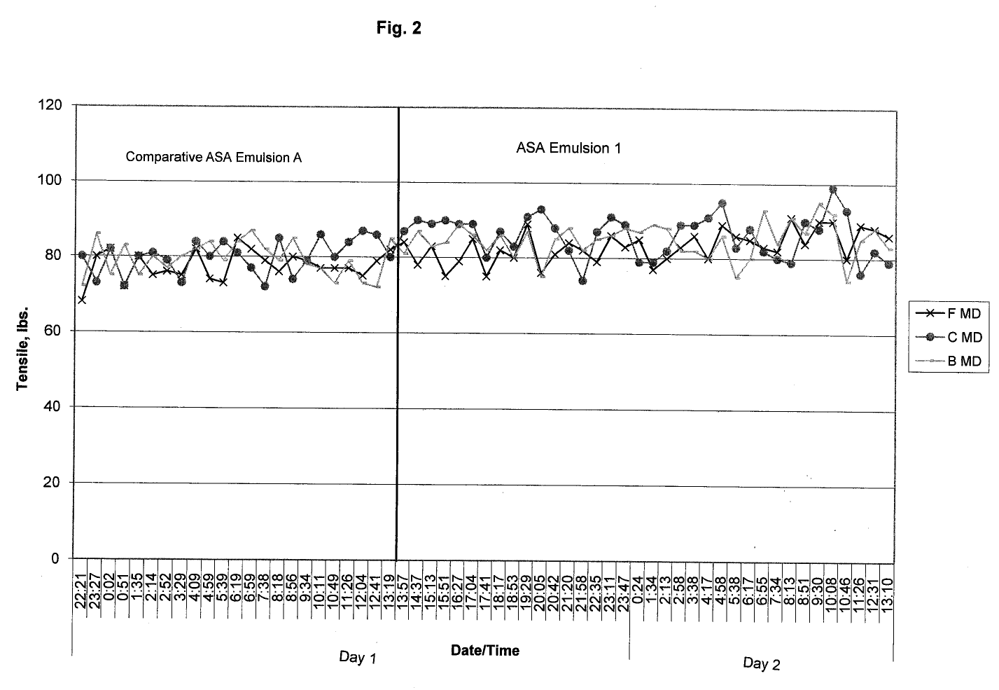

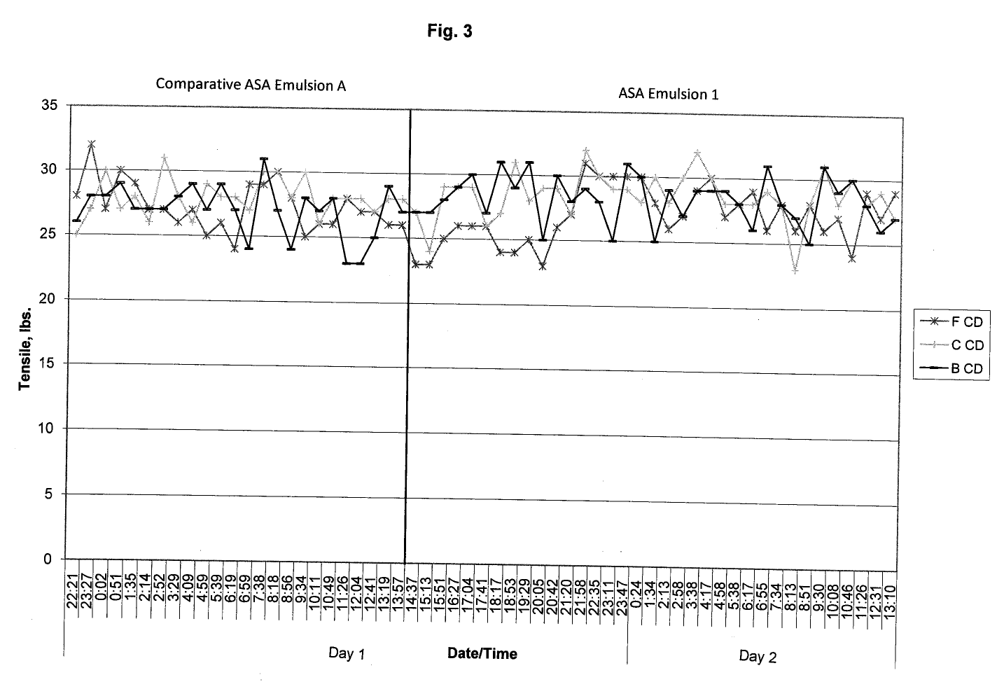

The different emulsions were separately added at the wet end of the gypsum-board liner production run at different periods of time, as indicated in FIGS. 1-3. The time units shown in FIGS. 1-3 are based on a 24 hour time:minute convention, and arbitrarily restarted at time period 24:00. The ASA dosage was kept constant during the experimental trial at 7.0 lbs./ton (pounds ASA per ton of dry paper) for all the tested emulsions. During the monitored period of production, the liner was periodically tested for water penetration by standard Cobb Sizing Test, measured as g/m² water absorbed in 60 seconds, with results as shown in FIG. 1. Also, MD and CD tensile properties of the liner were periodically measured with an Instron Tensile Tester, with results as shown in FIGS. 2-3. Tensile properties were determined in units of pounds (lbs.), and values were measured for the front (“F”), center (“C”), and back (“B”).

Referring to the results shown in FIG. 1, based on Cobb sizing performance, the liner treated with the ASA Emulsion 1 showed similar performance to that treated with the Comparative ASA emulsion A. Referring to the results shown in FIGS. 2 and 3, it also was observed from trial results that the MD tensile value increased by 7% and the CD tensile value increased by 2% for the liner treated with ASA Emulsion 1 as compared to the liner treated with the Comparative ASA Emulsion A.

During a separate production time period of liner production conducted on the same gypsum-board liner system, another ASA emulsion, ASA Emulsion 2 (“2”), was added at the wet end at the constant ASA dosage rate of 7 lbs./ton. ASA Emulsion 2 was similar in formulation to the above-described ASA Emulsion 1 except that a different ASA (≈C16 alkyl chain) component was used. A 5 gallon sample of this ASA Emulsion 2 was prepared on the conventional low shear mixer. As also shown in Table 7, the particle size results show that this ASA Emulsion 2 produced slightly smaller particle size and an even more enhanced quality emulsion than the ASA Emulsion 1.

TABLE 7

| | Median | Mean | | | |
|---|---|---|---|---|---|
| Emulsion | Size | Size | Std. | % | |
| Sample | (μm) | (μm) | Dev. | <1.5 microns | Comments |
| 1 | 1.11 | 1.2 | 0.52 | 76% | |
| 2 | 0.99 | 1.04 | 0.37 | 89% | |
| 2 | 0.97 | 1.03 | 0.37 | 89% | 1:30 Hr later |
| CA | 1.09 | 1.16 | 0.46 | 79% | |
| CA | 1.08 | 1.13 | 0.45 | 81% | Duplicate |

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It will be apparent to those skilled in the art that various modifications and variations can be made to the embodiments of the present invention without departing from the spirit or scope of the present invention. Thus, it is intended that the present invention covers other modifications and variations of this invention provided they come within the scope of the appended claims and their equivalents.

What is claimed is:

1. An ASA sizing emulsion comprising ASA, at least one starch, at least one acrylamide/quaternary ammonium compound/glyoxal terpolymer, and water.

2. The ASA sizing emulsion of claim 1, further comprising at least one anionic surfactant and at least one nonionic surfactant.

3. The ASA sizing emulsion of claim 2, wherein said ASA is present as ASA particles having an average particle size of from 0.5 to 1 micron.

4. The ASA sizing emulsion of claim 1, wherein said ASA sizing emulsion is emulsion (a) and comprising from about 0.5 to about 3 weight % ASA, from about 0.1 to about 1.5 weight % starch, from about 0.1 to about 1.5 weight % terpolymer, and from about 94 to about 99.3 weight % water.

5. The ASA sizing emulsion of claim 1, wherein said terpolymer comprises from 1 to 99 weight % acrylamide, from 1 to 99 weight % quaternary ammomum compound, and from 0.01 to 50 weight % glyoxal.

6. The ASA sizing emulsion of claim 1, wherein said quaternary ammonium compound is a quaternary ammonium salt monomer.

7. The ASA sizing emulsion of claim 6, wherein said quaternary ammonium salt monomer is dimethyldiallyl ammonium chloride.

8. The ASA sizing emulsion of claim 1, wherein the starch is cationic starch.

9. The ASA sizing emulsion of claim 1, wherein the sizing emulsion gives an HST value of at least 1000 seconds when dosed at 4 lb./ton in sizing 100% OCC.

10. The ASA sizing emulsion of claim 2, wherein the sizing emulsion gives an HST value of at least 1500 seconds when dosed at 4 lb./ton in sizing 100% OCC.

11. The ASA sizing emulsion of claim 2, wherein the sizing emulsion gives an HST value of at least 10 seconds when dosed at 4 lb./ton in sizing #30 sulfite pulp.

12. The ASA sizing emulsion of claim 2, wherein the sizing emulsion gives a Cobb sizing value, based on one minute, ranging from about 20 to about 100 grams per square meter for 100% OCC paperboard.

13. The ASA sizing emulsion of claim 2, containing comprising from about 0.6 to about 2.4 weight % ASA, from about 0.1 to about 0.3 weight % anionic surfactant, and from about 0.1 to about 0.3 weight % nonionic surfactant.

14. The ASA sizing emulsion of claim 2, wherein said anionic surfactant is dioctyl sulfosuccinate or a salt thereof.

15. The ASA sizing emulsion of claim 2, wherein said nonionic surfactant is polyoxyalkylene alkyl ether.

16. A process for sizing paper comprising treating wet paper pulp or paper with the ASA sizing emulsion of claim 1.

17. A process for sizing paper comprising treating wet paper pulp or paper with the ASA sizing emulsion of claim 2.

18. The process of claim 16, wherein the sizing emulsion gives an HST value of at least 1000 seconds when dosed at 4 lb./ton in sizing 100% OCC.

19. The process of claim 16, wherein the sizing emulsion gives an HST value of at least 1500 seconds when dosed at 4 lb./ton in sizing 100% OCC.

20. The process of claim 16, wherein the sizing emulsion gives an HST value of at least 10 seconds when dosed at 4 lb./ton in sizing #30 sulfite pulp.

21. The process of claim 16, wherein said ASA sizing emulsion is formed by blending under low shear conditions the ASA, the starch, and the acrylamide/quaternary ammonium compound/glyoxal terpolymer and water.

22. The process of claim 21, wherein said low shear conditions are achieved by a pump with a back pressure of 50 psi or less.

23. The process of claim 17, wherein said ASA sizing emulsion is formed by pre-combining the ASA with said anionic surfactant and nonionic surfactant to form an ASA blend which is combined with an emulsifying agent formed by said starch, and said acrylamide/quaternary ammonium compound/glyoxal terpolymer, and then blending together under low shear conditions to form said ASA sizing emulsion.

24. An ASA blend comprising ASA and at least one anionic surfactant and at least one nonionic surfactant.

25. An emulsifying agent comprising at least one starch and at least one acrylamide/quaternary ammonium compound/glyoxal terpolymer.
